(19) United States
(12) Patent Application Publication
(10) Pub. No.: US 2024/0428124 A1
(43) Pub. Date: Dec. 26, 2024

(54) OUTLIER DETECTION WITH TRANSFER LEARNING

(71) Applicant: International Business Machines Corporation, Armonk, NY (US)

(72) Inventors: Long Vu, Chappaqua, NY (US); Peter Daniel Kirchner, PUTNAM VALLEY, NY (US); Horst Cornelius Samulowitz, Armonk, NY (US); Charu C. Aggarwal, Yorktown Heights, NY (US)

(21) Appl. No.: 18/338,671

(22) Filed: Jun. 21, 2023

(51) Int. Cl. G06N 20/00

(52) U.S. Cl. CPC G06N 20/00

(57) ABSTRACT

Embodiments of the invention are directed to a computer system including a memory communicatively coupled to a processor system. The processor system is operable to perform processor system operations that include using a first machine learning (ML) algorithm to convert to-be-classified-data (TBC-data) from a TBC-data format to a second data format; and extract features from the TBC-data in the second data format. A second ML algorithm is used to perform a task that includes determining, based at least in part on the features of the TBC-data in the second data format, that the TBC-data having the second data format is an outlier.

### BACKGROUND

The present invention relates in general to programmable computers that prepare digital information for analysis. More specifically, the present invention relates to computing systems, computer-implemented methods, and computer program products that implement a novel outlier detection model/classifier operable to use transfer learning to detect and classify outlier data in a data set having diverse data formats and structures.

Data science combines math and statistics, specialized programming, advanced analytics, artificial intelligence (AI), and machine learning (ML) with specific subject matter expertise to uncover actionable insights hidden in an organization's data. These insights can be used to guide decision making and strategic planning.

An important consideration in data science is the quality of the data to be analyzed. Data quality can be impacted by so-called “outlier” or “anomaly” data. The term “outlier” refers to a data point or a set of data points that diverges dramatically from expected samples and patterns for their type. For a dataset that follows a standard bell curve, the outliers are the data on the far right and left. Outliers can indicate fraud or some other anomaly, but they can also be measurement errors, experimental problems, or a novel, one-off instance. With the world of data science growing, there has been an associated growth in the rate of data outliers and/or anomalies, which can hamper data analysis techniques and skew analysis results.

Outlier detection is the process of detecting outliers and, depending on the goals of the associated data analysis, remove or resolve them from the analysis to prevent any potential skewing. Outlier detection processes attempt to ensure that data analysis is performed on good, reliable data.

### SUMMARY

Embodiments of the invention are directed to a computer system including a memory communicatively coupled to a processor system. The processor system is operable to perform processor system operations that include using a first machine learning (ML) algorithm to convert to-be-classified-data (TBC-data) from a TBC-data format to a second data format; and extract or access features of the TBC-data in the second data format. A second ML algorithm is used to perform a task that includes determining, based at least in part on the features of the TBC-data in the second data format, that the TBC-data having the second data format is an outlier.

Embodiments of the invention are also directed to computer-implemented methods and computer program products having substantially the same features and functionality as the computer system described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2 depicts a simplified block diagram illustrating a system architecture embodying aspects of the invention;

FIG. 3 depicts a flow diagram illustrating a computer-implemented methodology according to aspects of the invention;

FIG. 4 depicts a simplified block diagram illustrating a system architecture embodying aspects of the invention;

FIG. 5 depicts a flow diagram illustrating a computer-implemented methodology according to aspects of the invention;

FIG. 6A depicts a machine learning system that can be utilized to implement aspects of the invention; and

FIG. 6B depicts a learning phase that can be implemented by the machine learning system shown in FIG. 6A.

In the accompanying figures and following detailed description of the disclosed embodiments, the various elements illustrated in the figures are provided with three-digit reference numbers. In some instances, the leftmost digits of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom very large scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The various components/modules of the systems illustrated herein are depicted separately for ease of illustration and explanation. In embodiments of the invention, the functions performed by the various components/modules can be distributed differently than shown without departing from the scope of the various embodiments of the invention describe herein unless it is specifically stated otherwise.

Turning now to an overview of technologies that are more specifically related to aspects of the invention, as previously noted herein, an important consideration in data science is the quality of the data to be analyzed. Data quality can be impacted by so-called “outlier” or “anomaly” data. The term “outlier” refers to a data point or a set of data points that diverges dramatically from expected samples and patterns for their type. For a dataset that follows a standard bell curve, the outliers are the data on the far right and left. Outliers can indicate fraud or some other anomaly, but they can also be measurement errors, experimental problems, or a novel, one-off instance. With the world of data science growing, there has been an associated growth in the rate of data outliers and/or anomalies, which can hamper data analysis techniques and skew analysis results.

Outlier detection is the process of detecting outliers and, depending on the goals of the associated data analysis, remove or resolve them from the analysis to prevent any potential skewing. Outlier detection processes attempt to ensure that data analysis is performed on good, reliable data. Conventional outlier detection processes often attempt to outlier detection methods that work on a particular type of data set. Other outlier detection processes use meta features of a data set to make a prediction about the performance of a given outlier detection algorithm on that data set. It would be beneficial to provide a single outlier detection model that finds outlier for diverse types of data set. However, it is very challenging to train a one-size-fits-all outlier detection model that is accurate and computationally efficient.

Turning now to an overview of aspects of the invention, embodiments of the invention provide computing systems, computer-implemented methods, and computer program products that implement a novel outlier detection model/classifier operable to detect and classify outlier data in a data set having diverse data formats and structures. Electronic information can be categorized as structured, semi-structured, or unstructured. Unstructured electronic information is not organized in a uniform format and can include text, images, video, and audio material. Virtually all of the electronic information generated in the day-to-day functions of businesses, academic institutions, non-business enterprises, and individuals is unstructured. Semi-structured electronic information includes some form of organization but the chosen organization method lacks consistency, is not standardized, or has some other deficiency. Structured electronic information is well-organized and arranged in a systematic, easily accessible way, including, for example, organizing the electronic information into an addressable repository or a database. A data element's structure identifies how variables or data elements are related to each other in to form coherent information that can be read and analyzed, for example, by a programming tool.

Two data sets can be considered diverse when one of the data sets has data structure(s) and format(s) that are different from (with or without overlap) the other data set. The novel outlier detection model, in accordance with aspects of the invention, is configured and arranged as a one-size-fits-all outlier detection model that detects outlier data in a first data set and a second data set, even when the first data set has a different data structure and data format than the data structure and data format of the second data set. The preceding examples reference two data sets for ease of explanation, and it should be understood that embodiments of the invention are designed to evaluate any number of data sets that are diverse with respect to one another.

An outlier detection system in accordance with aspects of the invention can include a data set scan module, a transfer learning module, and a classifier. The data set scan module is operable to scan a large number of data set sources (e.g., 10,000 or more) that each includes labeled inlier data and labeled outlier data. The data set scan operations extract from the data set sources their labeled inlier data and the labeled outlier data. In embodiments of the invention, the extracted labeled inlier/outlier data are diverse in that they have or include a diverse set of data formats and structures. The transfer learning module is trained using the diverse labeled inlier/outlier data to uncover a uniform data set structure/format to which the diverse inlier/outlier data structures/formats can be converted. In some embodiments of the invention, the transfer learning module can include pipelines associated with the data set sources that are trained, using the extracted diverse labeled inlier/outlier data structures/formats, to perform conversions from the diverse data structures/formats to the uniform data set structures/formats. When in the uniform data set structures/formats, transformed features can be extracted from the converted data. The classifier is operable to use the inlier outlier data set labels and the transformed features of the data that has been converted to the uniform data set structure/format to generate a supervised learning problem on which an outlier classification model of the classifier is built/trained. The supervised learning problem trains the outlier classification model to predict, working in tandem with the trained transfer learning module, whether new and unseen data of a data set having its own data structure/format is an outlier or not. In embodiments of the invention, the new and unseen data of the data set having its own data structure/format is passed through the trained transfer learning module to convert the new and unseen data of the data set to the uniform data set structure/format, and the classifier and outlier classification model performs its classification task on the new and unseen data of the data set in the uniform data set structure/format.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

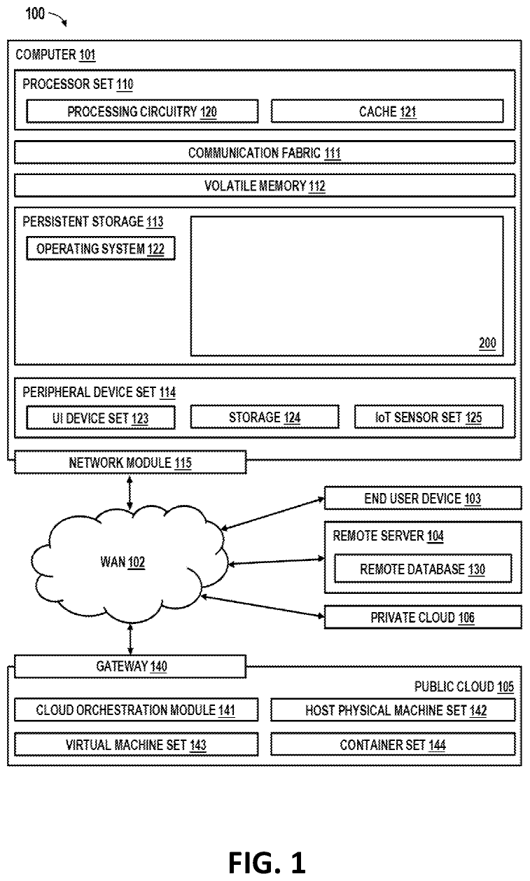

FIG. 1 depicts a computing environment 100 that contains an example of an environment for the execution of at least some of the computer code involved in performing the inventive methods, such as code block 200 operable to implement a novel outlier detection model/classifier operable to use transfer learning to detect and classify outlier data in a data set having diverse data formats and structures. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

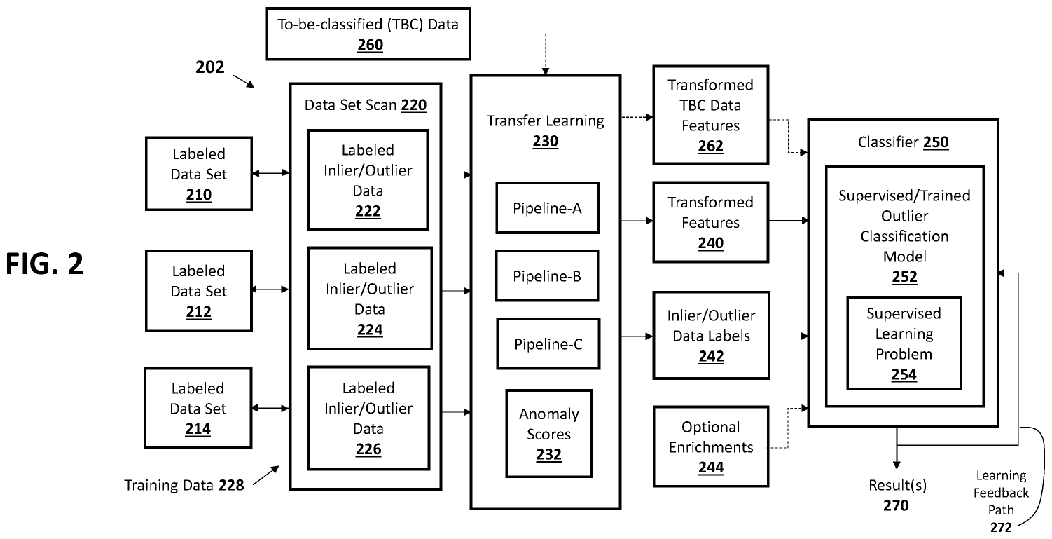

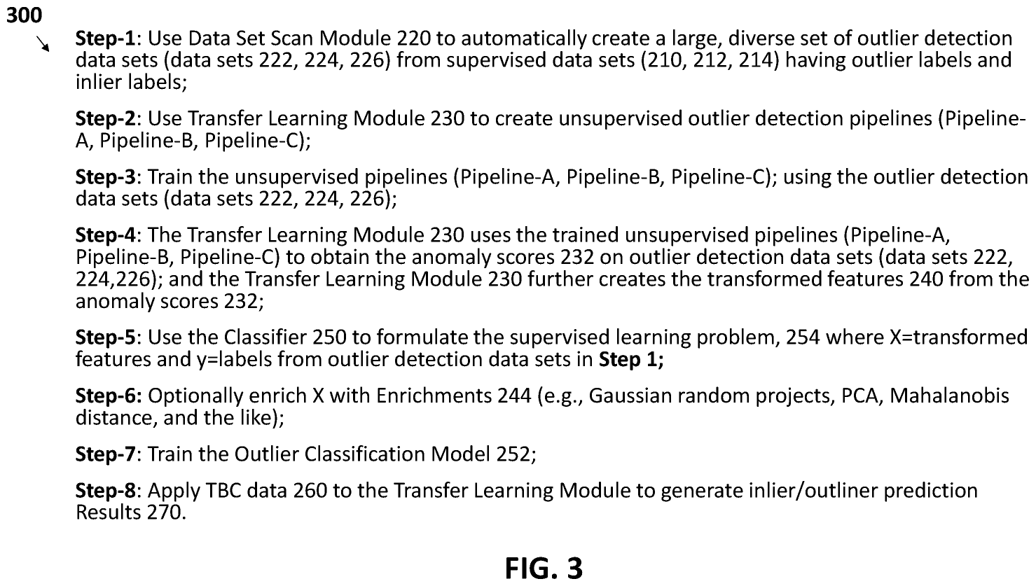

FIG. 2 depicts a simplified block diagram illustrating a system 202 operable to implement embodiments of the invention. FIG. 3 depicts a flow diagram illustrating a computer-implemented methodology 300 operable to be performed by the system 202 according to aspects of the invention. The following description of the system 202 refers to components and operations of the system 202 shown in FIG. 2, and, where appropriate, also refers to the corresponding operations/steps of the methodology 300 shown in FIG. 3.

The system 202 includes a data set scan module 220, a transfer learning module 230, and a classifier 250, configured and arranged as shown. The data set scan module 220 is operable to access a large number of labeled data set sources (e.g., 10,000 or more) (Step-1 of FIG. 3) each having labeled data where the data label indicates whether its associated data is an instance of inlier data or an instance of outlier data. The term “inlier” refers to a data point or a set of data points that do not diverge dramatically from expected samples and patterns for their type. The term “outlier” refers to a data point or a set of data points that diverge dramatically from expected samples and patterns for their type. For a dataset that follows a standard bell curve, the outliers are the data on the far right and left. Outliers can indicate fraud or some other anomaly, but they can also be measurement errors, experimental problems, or a novel, one-off instance. In FIG. 2, for ease of illustration and explanation, the large number of labeled data set sources are represented as three (3) labeled data sets, namely, labeled data set 210, labeled data set 212, and labeled data set 214. The labeled inlier/outlier data sets extracted by the data set scan module 220 from the labeled data set 210, the labeled data set 212, and the labeled data set 214 are represented by labeled inlier/outlier data set 222, labeled inlier/outlier data set 224, and labeled inlier/outlier data set 226, respectively. The labeled inlier/outlier data set 222, the labeled inlier/outlier data set 224, and the labeled inlier/outlier data set 226 also have diverse data formats and structures, which are also captured as part of the labeled inlier/outlier data set 222, the labeled inlier/outlier data set 224, and the labeled inlier/outlier data set 226.

In general, the transfer learning module 230 is operable to perform transfer learning tasks that leverage model parameters (e.g., labeled data and associated data formats/structures) that are ideal for one task (e.g., detecting and classify outlier data having that same format/structure) and using it instead as part of the development of another task (e.g., detecting and classifying outlier data having a uniform or generic data format/structure that can be used as a one-size-fits-all data format/structure). The transfer learning module 230 is trained using the large number of labeled inlier/outlier data and data formats/structures represented by the labeled inlier/outlier data set 222, the labeled inlier/outlier data set 224, and the labeled inlier/outlier data set 226 (Step-3 of FIG. 3). Accordingly, the large number of labeled inlier/outlier data and data formats/structures represented by the labeled inlier/outlier data set 222, the labeled inlier/outlier data set 224, and the labeled inlier/outlier data set 226 function as training data 228 for the transfer learning module 230.

The training operations of the transfer learning module 230 includes extracting features from the large number of labeled inlier/outlier data and data formats/structures represented by the labeled inlier/outlier data set 222, the labeled inlier/outlier data set 224, and the labeled inlier/outlier data set 226. The transfer learning module 230 uses these extracted features to understand the patterns and relationships that govern the large number of labeled inlier/outlier data and data formats/structures represented by the labeled inlier/outlier data set 222, the labeled inlier/outlier data set 224, and the labeled inlier/outlier data set 226. The learned patterns and relationships are used by the transfer learning module 230 to uncover a function (or functions) for converting a data set from its current format to a generic data format/structure that can be used as a one-size-fits-all data format/structure.

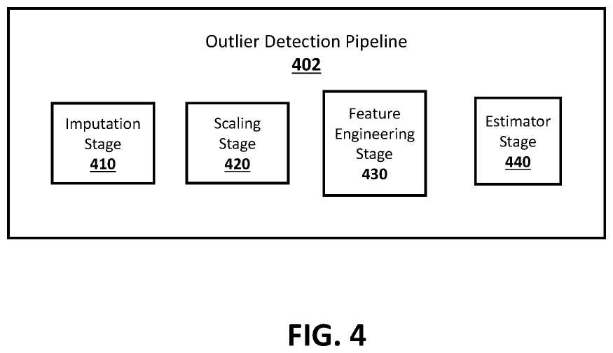

In some embodiments of the invention, the transfer learning module 230 performs the above-described transfer learning function(s) by using as set of pipelines, namely, Pipeline-A, Pipeline-B, and Pipeline-C (Step-2). Although only three (3) examples of pipelines are shown in FIG. 2, it is understood that any number of pipeline paths can be provided based on the volume and structure of the training data 228. In general, the set of pipelines used by the transfer learning module 230 each includes a series of steps that allow data from one system to move to and become useful in another system, particularly analytics, data science, and/or or AI/ML systems. At a high level, a data pipeline works by pulling data from the source, applying rules for transformation and processing, then pushing the transformed data to its destination. In embodiments of the invention, the pipelines (Pipeline-A, Pipeline-B, Pipeline-C) are matched to characteristic of the training data 228 that are relevant to the transfer learning operations and tasks. For example, the characteristics of the training data 228 can include the range of data formats/structures in the data set scan module 220. The data formats/structures in the labeled inlier/outlier data set 222 can be sufficiently consistent that one pipeline can be created for the labeled inlier/outlier data 220. By contrast, four (4) distinct data formats/structures can be present in the labeled inlier/outlier data set 224, which would result in a pipeline being provided for each of the four (4) distinct data formats/structures in the labeled inlier/outlier data set 224. A non-limiting example of how Pipeline-A, Pipeline-B, Pipeline-C can each be implemented as an outlier detection pipeline 402 is shown in FIG. 4 and described in greater detail subsequently herein.

In embodiments of the invention, the computing environment (e.g., computing environment 100 shown in FIG. 1) can include computer-aided design (CAD) functionality to perform and/or automate the design operations (e.g., selection and configuration of the pipelines of the transfer learning module 230) of the system 202. CAD software can be used to create two-dimensional (2-D) drawings or three-dimensional (3-D) models of a system-under-design (SUD). CAD software generally includes a variety of tools that enable a designer to optimize and streamline workflow; increase productivity; improve the quality and level of detail in the design; improve documentation communications; and often contribute toward a manufacturing design database. CAD software outputs come in the form of electronic files, which can be used in tandem with computer-aided manufacturing (CAM) software to control manufacturing and/or fabrication processes. CAD/CAM is software routinely used to design products such as electronic circuit boards in computers and other devices.

In some embodiments of the invention, the transfer learning module 230 also learns to generate anomaly scores from the outputs generated by the pipelines of the transfer learning module 230. The transfer learning module 230 concatenates the generated anomaly scores and uses the concatenated to create a training set of anomaly scores 232 (Step-4 of FIG. 3). The transfer learning module 230 uses the anomaly scores 232 to create transformed features 240 (Step-4 of FIG. 3), which are features of the data sets that have been converted by the transfer learning module 230 from their as-extracted format/structure to a generic data format/structure that can be used as a one-size-fits-all data format/structure. The transformed features 240 and inlier/outlier data labels 242 (which are taken from the labeled inlier/outlier data set 222, the labeled inlier/outlier data set 224, and the labeled inlier/outlier data set 226 extracted by the data set scan module 260) are provided to the classifier 250.

The classifier 250 includes an outlier classification model 252 and a supervised learning problem 254. The classifier 250 is operable to use the inlier/outlier data set labels 242, the transformed features 240, and optional transferred feature enrichments 244 (e.g., Gaussian random projections, principal component analysis (PCA), Mahalanobis distances, and the like) to generate the supervised learning problem 254 on which the outlier classification model 252 of the classifier 250 is built/trained (Step-5 and Step-6 of FIG. 3). The supervised learning problem 254 trains the outlier classification model 252 to predict, working in tandem with the trained pipelines of the transfer learning module 230, whether to-be-classified (TBC) data 260 of a data set having its own data structure/format is an outlier or not (Step-7 of FIG. 3). In embodiments of the invention, the TBC data 260 having its own data structure/format is passed through the trained transfer learning module 230, which applies the previously-described transfer learning functions to the TBC data 260 to generate transformed TBC data features 262, which correspond to the transformed features 240 used to train the outlier classification module 252. The classifier 250 is operable to use the inlier/outlier data set labels 242, the transformed TBC data features 262, and optional transferred feature enrichments 244 to generate the results 270, which are predictions of whether the TBC data 260 of a data set having its own data structure/format is an outlier or not (Step-8 of FIG. 3). In embodiments of the invention, the results 272 can be provide through a learning feedback path 272 to provide further training of the classifier 250.

Additional details of how various aspects of the system 202 can be implemented in accordance with some embodiment of the invention will now be described. With respect to the data set scan module 220, in some aspects of the invention, the labeled data sets 210, 212, 214 can be downloaded from publicly available sources, including, but not limited to, open source databases. The labeled outlier detection data sets can be created by the data scan module 220 using the following operations. A pair of classes in the original data set is selected, and a class is down-sampled to make it a minority class (i.e., label these records as outliers). The other class is the majority class (i.e., label these records as inliers). This creates a data set D with binary labels of zero (0) and one (1) for inlier and outlier, respectively. In experiments performed in connection with embodiment of the invention, one percent (1%) of the data set was identified as outliers. Given this derived data set D. “Isolation Forest” and “Average KNN” outlier detection methods are performed over D. The outlier, inlier labels are used to calculate received operator characteristic (ROC) scores. If the ROC scores generated by “Isolation Forest” and “Average KNN” are both greater than one half (0.5), D is considered an outlier data set in the collection. This selection criteria is used to ensure that D is an outlier detection data set. In experiments performed in connection with embodiment of the invention, a set(S) of 520 such data sets was created, which had six million (6M) data records in total. In experiments performed in connection with embodiment of the invention, each outlier data set D had one percent (1%) of outliers, and the overall data from S also had one percent (1%) outliers.

With respect to the pipelines (Pipeline-A, Pipeline-B, Pipeline-C) of the transfer learning module 430, the pipelines are trained on the derived outlier detection data sets (e.g., labeled inlier/outlier data 222, 224, 226). This provides anomaly scores, which indicate how abnormal records are in these derived outlier detection data sets. For each data record, one pipeline gives one anomaly score, so 400 pipelines give 400 anomaly scores. For the six million (6M) records from five hundred and twenty (520) outlier detection data sets, a matrix of 6M×400 can be created. Thus, the final data set includes (X, y): X is (6M, 400) and y is (6M, 1), where the labels are taken from the 520 outlier detection data sets.

FIG. 4 depicts a simplified block diagram illustrating a non-limiting example of how Pipeline-A, Pipeline-B, Pipeline-C (shown in FIG. 2) can each be implemented as an outlier detection pipeline 402. The outlier detection pipeline includes multiple stages, including an imputation stage 410, a scaling stage 420, a feature engineering stage 430, and an estimator stage 440, configured and arranged as shown. The outlier detection pipeline 402 uses a series of “transforms” with a final estimator. The pipeline 402 sequentially applies a list of transforms (stages 410, 420, 430) and a final estimator (stage 440). The intermediate stages of the pipeline 402 are “transforms” in that they implement fit and transform methods. The final estimator 440 only needs to implement fit. The transformers in the pipeline 402 can be cached using memory argument. The purpose of the pipeline 402 is to assemble several steps that can be cross-validated together while setting different parameters. For this, the pipeline 402 enables setting parameters of the various stages using their names and the parameter name. The imputation stage 410 is operable to utilize various tools and technique to perform the operations described herein, including, for example, “simpler imputer” techniques and “iterative imputer” techniques. The scaling stage 420 is operable to utilize various tools and technique to perform the operations described herein, including, for example, “standard scaler.” “normalizer,” “MaxAbsScaler,” “MinMaxScaler,” “robust scaler,” and the like. The feature engineering stage 430 is operable to utilize various tools and technique to perform the operations described herein, including, for example, “polynomial features” and “PCA.” The estimator stage 440 is operable to utilize various tools and technique to perform the operations described herein, including, for example, “isolation forest,” “average KNN,” “ElipseticEvelop,” “LOF,” “randomize hashing,” “one class SVM,” “copula-based outlier detection.” “PCA,” and the like. Each component of the outlier detection pipeline 402 can include tens of hyperparameters (e.g., isolation forest has n_estimators and max_features) in various ranges. These values can be taken at random in their ranges, and thus create ten thousand (10000) pipelines in total. Four hundred (400) random pipelines can be selected to train, produce the anomaly scores 232, and used to classify TBC data 260.

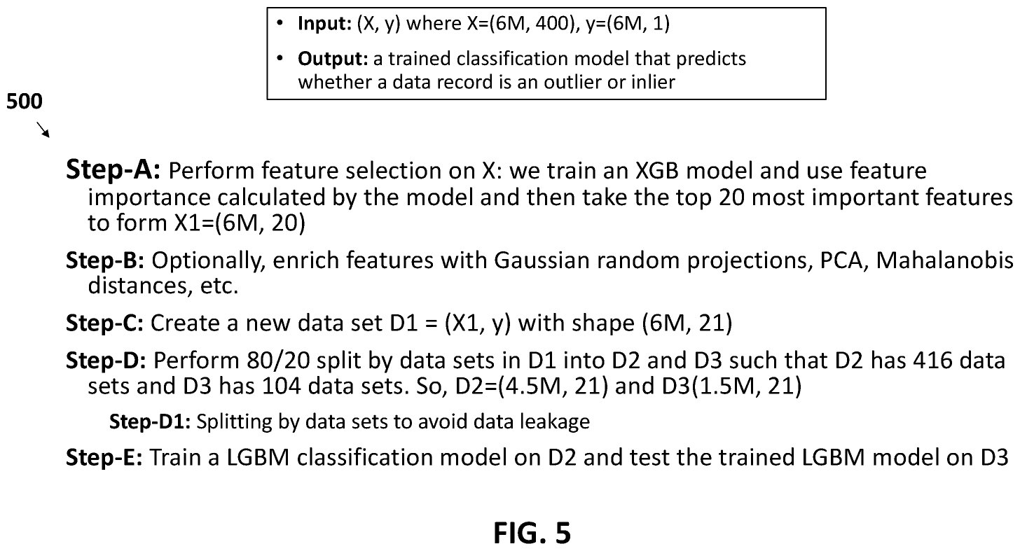

FIG. 5 depicts a flow diagram illustrating a computer-implemented methodology 500 illustrating a non-limiting example of how the classifier 250 (shown in FIG. 1) can be trained according to aspects of the invention. As shown in FIG. 5, the Input to the classifier 250 can be: (X, y) where X=(6M, 400) and y=(6M, 1). As also shown in FIG. 5, the Output (e.g., the results 270 shown in FIG. 2) from the classifier 250 can be the trained outlier classification model 252 that predicts whether a data record is an outlier or an inlier. The methodology 500 begins at Step-A by performing feature selection on X. An extreme gradient boosting (XGBoost or XGB) model is trained, and the feature importance calculated by the model is used to take the top twenty (20) most important features to form X1=(6M, 20). At Step-B, optionally, the features are enriched with Gaussian random projections, PCA, Mahalanobis distances, and the like. At Step-C, a new data set D1=(X1, y) is created with shape (6M, 21). At Step-D, an 80/20 split is performed to segment data sets in D1 into D2 and D3 such that D2 has four hundred and sixteen (416) data sets, and D3 has one hundred and four (104) data sets. Accordingly, D2=(4.5M, 21) and D3=(1.5M, 21). In some embodiments of the invention, Step-D1 splits data sets to avoid data leakage. At Step-D, a light gradient boosting model (LGBM) classification model is trained on D2. The trained LGBM model is tested on D3.

Because the above-described binary classification model was trained on D2, which has a shape of (4.8M, 21), the list of twenty (20) most important features is maintained. These twenty (20) features are trained pipelines that produce anomaly scores. Optionally, additional features are computed, if used, such as Gaussian random projections, PCA, Mahalanobis distance, and the like. Given an unseen data set X2, these trained pipelines are first used to score X2 to form the test set X3 of anomaly scores (i.e., X3 has twenty (20) columns, each is produced by one trained pipeline). In embodiments of the invention, rows of X2 and X3 are aligned. X3 then is the test set for the trained binary classification model to predict outliers and inliers for data records of X2.

Thus, it can be seen from the foregoing detailed description that embodiments of the invention provide computing systems, computer-implemented methods, and computer program products that implement a novel outlier detection model/classifier operable to detect and classify outlier data in a data set having diverse data formats and structures. Embodiments of the invention are operable to convert an unsupervised learning problem (i.e., outlier detection) into a supervised learning problem (i.e., binary classification) and solve it effectively stepwise by building a classification model for predicting outliers by: automating creation of a large, diverse outlier detection data sets with anomaly labels; transforming these datasets with a diverse subset of outlier detection pipelines into a representation consisting of anomaly scores from the selected pipelines; concatenating the anomaly score representation of diverse subset of the datasets to create a training set; and using the training set (anomaly score representation) and the labels (outlier/inlier) to train a supervised learning classification model, which will predict each label directly. The trained model is deployed on new data by generating the anomaly score representation for the new dataset(s) using the above-described transforming operation; and predicting outlier labels with the trained classification model. Thus, embodiment of the invention convert an unsupervised problem into a supervised problem in a novel way that includes creating outlier data sets for meta learning from supervised data sets; and combining anomaly scores and labels to formulate a classification problem for outlier detection.

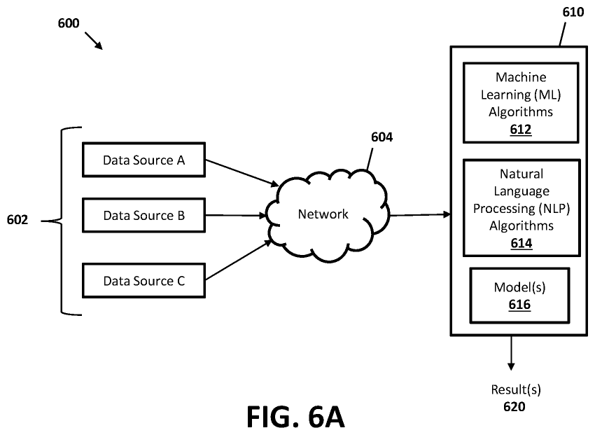

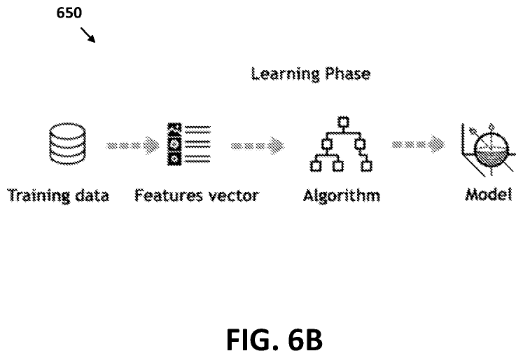

FIG. 6A depicts a block diagram showing a machine learning or classifier system 600 capable of implementing various aspects of the invention described herein. More specifically, the functionality of the system 600 is used in embodiments of the invention to generate various models and sub-models that can be used to implement computer functionality in embodiments of the invention. The system 600 includes multiple data sources 602 in communication through a network 604 with a classifier 610. In some aspects of the invention, the data sources 602 can bypass the network 604 and feed directly into the classifier 610. The data sources 602 provide data/information inputs that will be evaluated by the classifier 610 in accordance with embodiments of the invention. The data sources 602 also provide data/information inputs that can be used by the classifier 610 to train and/or update model(s) 616 created by the classifier 610. The data sources 602 can be implemented as a wide variety of data sources, including but not limited to, sensors configured to gather real time data, data repositories (including training data repositories), and outputs from other classifiers. The network 604 can be any type of communications network, including but not limited to local networks, wide area networks, private networks, the Internet, and the like.

The classifier 610 can be implemented as algorithms executed by a programmable computer such as a computing environment 1000 (shown in FIG. 11). As shown in FIG. 6A, the classifier 610 includes a suite of machine learning (ML) algorithms 612; natural language processing (NLP) algorithms 614; and model(s) 616 that are relationship (or prediction) algorithms generated (or learned) by the ML algorithms 612. The algorithms 612, 614, 616 of the classifier 610 are depicted separately for ease of illustration and explanation. In embodiments of the invention, the functions performed by the various algorithms 612, 614, 616 of the classifier 610 can be distributed differently than shown. For example, where the classifier 610 is configured to perform an overall task having sub-tasks, the suite of ML algorithms 612 can be segmented such that a portion of the ML algorithms 612 executes each sub-task and a portion of the ML algorithms 612 executes the overall task. Additionally, in some embodiments of the invention, the NLP algorithms 614 can be integrated within the ML algorithms 612.

The NLP algorithms 614 include speech recognition functionality that allows the classifier 610, and more specifically the ML algorithms 612, to receive natural language data (text and audio) and apply elements of language processing, information retrieval, and machine learning to derive meaning from the natural language inputs and potentially take action based on the derived meaning. The NLP algorithms 614 used in accordance with aspects of the invention can also include speech synthesis functionality that allows the classifier 610 to translate the result(s) 620 into natural language (text and audio) to communicate aspects of the result(s) 620 as natural language communications.

The NLP and ML algorithms 614, 612 receive and evaluate input data (i.e., training data and data-under-analysis) from the data sources 602. The ML algorithms 612 includes functionality that is necessary to interpret and utilize the input data's format. For example, where the data sources 602 include image data, the ML algorithms 612 can include visual recognition software configured to interpret image data. The ML algorithms 612 apply machine learning techniques to received training data (e.g., data received from one or more of the data sources 602) in order to, over time, create/train/update one or more models 616 that model the overall task and the sub-tasks that the classifier 610 is designed to complete.

Referring now to FIGS. 6A and 6B collectively, FIG. 6B depicts an example of a learning phase 650 performed by the ML algorithms 612 to generate the above-described models 616. In the learning phase 650, the classifier 610 extracts features from the training data and coverts the features to vector representations that can be recognized and analyzed by the ML algorithms 612. The features vectors are analyzed by the ML algorithm 612 to “classify” the training data against the target model (or the model's task) and uncover relationships between and among the classified training data. Examples of suitable implementations of the ML algorithms 612 include but are not limited to neural networks, support vector machines (SVMs), logistic regression, decision trees, hidden Markov Models (HMMs), etc. The learning or training performed by the ML algorithms 612 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier 610 and the ML algorithms 612. Unsupervised learning can utilize additional learning/training methods including, for example, clustering, anomaly detection, neural networks, deep learning, and the like.

When the models 616 are sufficiently trained by the ML algorithms 612, the data sources 602 that generate “real world” data are accessed, and the “real world” data is applied to the models 616 to generate usable versions of the results 620. In some embodiments of the invention, the results 620 can be fed back to the classifier 610 and used by the ML algorithms 612 as additional training data for updating and/or refining the models 616.

In aspects of the invention, the ML algorithms 612 and the models 616 can be configured to apply confidence levels (CLs) to various ones of their results/determinations (including the results 620) in order to improve the overall accuracy of the particular result/determination. When the ML algorithms 612 and/or the models 616 make a determination or generate a result for which the value of CL is below a predetermined threshold (TH) (i.e., CL<TH), the result/determination can be classified as having sufficiently low “confidence” to justify a conclusion that the determination/result is not valid, and this conclusion can be used to determine when, how, and/or if the determinations/results are handled in downstream processing. If CL>TH, the determination/result can be considered valid, and this conclusion can be used to determine when, how, and/or if the determinations/results are handled in downstream processing. Many different predetermined TH levels can be provided. The determinations/results with CL>TH can be ranked from the highest CL>TH to the lowest CL>TH in order to prioritize when, how, and/or if the determinations/results are handled in downstream processing.

In aspects of the invention, the classifier 610 can be configured to apply confidence levels (CLs) to the results 620. When the classifier 610 determines that a CL in the results 620 is below a predetermined threshold (TH) (i.e., CL<TH), the results 620 can be classified as sufficiently low to justify a classification of “no confidence” in the results 620. If CL>TH, the results 620 can be classified as sufficiently high to justify a determination that the results 620 are valid. Many different predetermined TH levels can be provided such that the results 620 with CL>TH can be ranked from the highest CL>TH to the lowest CL>TH.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer system comprising a memory communicatively coupled to a processor system, wherein the processor system is operable to perform processor system operations comprising:
using a first machine learning (ML) algorithm to:
convert to-be-classified-data (TBC-data) from a TBC-data format to a second data format; and
access features of the TBC-data in the second data format; and
using a second ML algorithm to perform a task comprising determining, based at least in part on the features of the TBC-data in the second data format, that the TBC-data having the second data format is an outlier.

2. The computer system of claim 1, wherein the first ML algorithm comprises a transfer learning algorithm.

3. The computer system of claim 1, wherein the transfer learning algorithm comprises an outlier detection pipeline.

4. The computer system of claim 1, wherein the TBC-data format is different from the second data format.

5. The computer system of claim 1, wherein the transfer algorithm has been trained based at least in part on a plurality of diverse outlier labels.

6. The computer system of claim 1, wherein:
the features of the TBC-data in the second data format are determined based at least in part on anomaly scores generated by the first ML algorithm; and
the task further comprises determining, based at least in part on a plurality of diverse outlier labels, that the TBC-data having the second data format is the outlier.

7. The computer system of claim 1, wherein:
the first ML algorithm comprises a transfer learning algorithm; and
the second ML algorithm comprises a classifier.

8. A computer-implemented method comprising:
using a first machine learning (ML) algorithm to:
convert to-be-classified-data (TBC-data) from a TBC-data format to a second data format; and
access features of the TBC-data in the second data format; and
using a second ML algorithm to perform a task comprising determining, based at least in part on the features of the TBC-data in the second data format, that the TBC-data having the second data format is an outlier.

9. The computer-implemented method of claim 8, wherein the first ML algorithm comprises a transfer learning algorithm.

10. The computer-implemented method of claim 8, wherein the transfer learning algorithm comprises an outlier detection pipeline.

11. The computer-implemented method of claim 8, wherein the TBC-data format is different from the second data format.

12. The computer-implemented method of claim 8, wherein the transfer algorithm has been trained based at least in part on a plurality of diverse outlier labels.

13. The computer-implemented method of claim 8, wherein:
the features of the TBC-data in the second data format are determined based at least in part on anomaly scores generated by the first ML algorithm; and
the task further comprises determining, based at least in part on a plurality of diverse outlier labels, that the TBC-data having the second data format is the outlier.

14. The computer-implemented method of claim 8, wherein:
the first ML algorithm comprises a transfer learning algorithm; and
the second ML algorithm comprises a classifier.

15. A computer program product comprising a computer readable program stored on a computer readable storage medium, wherein the computer readable program, when executed on a processor system, causes the processor to perform processor system operations comprising:
using a first machine learning (ML) algorithm to:
convert to-be-classified-data (TBC-data) from a TBC-data format to a second data format; and
access features of the TBC-data in the second data format; and
using a second ML algorithm to perform a task comprising determining, based at least in part on the features of the TBC-data in the second data format, that the TBC-data having the second data format is an outlier.

16. The computer program product of claim 15, wherein the first ML algorithm comprises a transfer learning algorithm.

17. The computer program product of claim 15, wherein the transfer learning algorithm comprises an outlier detection pipeline.

18. The computer program product of claim 15, wherein the TBC-data format is different from the second data format.

19. The computer program product of claim 15, wherein the transfer algorithm has been trained based at least in part on a plurality of diverse outlier labels.

20. The computer system of claim 1, wherein:
the features of the TBC-data in the second data format are determined based at least in part on anomaly scores generated by the first ML algorithm;
the task further comprises determining, based at least in part on a plurality of diverse outlier labels, that the TBC-data having the second data format is the outlier;
the first ML algorithm comprises a transfer learning algorithm; and
the second ML algorithm comprises a classifier.
